(19) United States
(12) Patent Application Publication
(10) Pub. No.: US 2023/0316354 A1
(43) Pub. Date: Oct. 5, 2023

(54) ONLINE MEDICAL MARKETPLACE

(71) Applicant: The Recovery Shop, LLC, Glastonbury, CT (US)

(72) Inventor: Michael N. Bordieri, JR., Somers, NY (US)

(21) Appl. No.: 18/161,925

(22) Filed: Jan. 31, 2023

Related U.S. Application Data
(60) Provisional application No. 63/362,068, filed on Mar. 29, 2022.

(51) Int. Cl. G06Q 30/0601

(52) U.S. Cl. CPC G06Q 30/0605; G06Q 30/0641; G06Q 30/0631

(57) ABSTRACT

Methods and systems for providing a customizable online marketplace are provided. A database server and database for providing website information over a network are provided. An application server is provided for rendering a website connected to the database server via the network, the website comprising one or more online marketplaces, each of the one or more online marketplaces being specific to a particular doctor and offering medical devices recommended by the particular doctor for purchase by a patient. A secure seller portal is provided for each doctor to access the corresponding online marketplace and to upload product information and product sales listings to the corresponding online marketplace. User systems enable the patient to securely access the website, choose the corresponding online marketplace associated with their doctor, and purchase one or more of the medical devices recommended by their doctor. A payment processing system enables processing of the purchases.

This application claims the benefit of U.S. Provisional Application No. 63/362,068 filed on Mar. 29, 2022, which is incorporated herein and made a part hereof by reference for all purposes.

### BACKGROUND OF THE INVENTION

The present invention relates to an online medical marketplace. More specifically, the present invention relates to methods and systems for providing a customizable single point of sale online marketplace for the sale of medical devices from multiple sources.

Currently, when a doctor recommends a medical device to a patient to aid in their recovery, such as braces, compression garments, cold therapy devices, or the like, the patient must then go to public source (e.g., Amazon, CVS, or medical supply stores) in an attempt to locate the correct device and purchase it.

It would be advantageous to provide a customizable online marketplace which consolidates medical devices recommended by a particular doctor for access by a patient that overcomes the disadvantages of shopping for medical devices via public sources.

The methods and systems of the present invention provide the foregoing and other advantages.

### SUMMARY OF THE INVENTION

The present invention relates to methods and systems for providing a customizable single point of sale online marketplace for the sale of medical devices from multiple sources.

In one example embodiment of the present invention, a system for providing a customizable online marketplace is provided. The system comprises a database server and database for providing website information over a network and an application server for rendering a website connected to the database server via the network. The website comprises one or more online marketplaces, each of the one or more online marketplaces being specific to a particular doctor and offering medical devices recommended by the particular doctor for purchase by a patient. For each of the one or more online marketplaces, a secure seller portal is provided for each doctor to access the corresponding online marketplace and to upload product information and product sales listings to the corresponding online marketplace. In addition, one or more user systems are provided, enabling the patient to securely access the website, choose the corresponding online marketplace associated with their doctor, and purchase one or more of the medical devices recommended by their doctor. A payment processing system in communication with the network enables processing of the purchases.

Each online marketplace may comprise one or more drop down menus listing one or more of medical procedures, body parts, and injuries. The selection of a particular medical procedure, body part, or injury from the one or more drop-down menus renders one or more recommended medical devices for purchase by the patient.

Alternatively, patient access to the doctor's corresponding online marketplace may be enabled via a link provided to the patient in a text or email.

The portal may enable each doctor to upload patient information accessible only by the corresponding patient, including but not limited to medical history, surgical history, contact information, prescription information, and medical device recommendations.

The medical devices may comprise at least one of durable medical devices provided by the doctors or durable medical devices provided by third-party vendors.

Methods corresponding to the above-referenced system embodiments are also provided.

### BRIEF DESCRIPTION OF THE DRAWINGS

The present invention will hereinafter be described in conjunction with the appended drawing FIGURE:

FIG. 1 shows an example embodiment of a system for providing a customizable online marketplace.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

The present invention relates to methods and systems for providing a customizable single point of sale online marketplace for the sale of medical devices, in particular durable medical equipment not typically covered by insurance. Note in the description below the term “doctor” is used to denote any type of medical doctor, including but not limited to a surgeon, an orthopedic surgeon, a family doctor, a pediatric doctor or the like. Those skilled in the art will also note that the online marketplace can also be provided for a physical or occupational therapist or other medical professional that prescribes or recommends medical devices.

In one example embodiment of an online marketplace in accordance with the present invention, a doctor will be provided with a customizable marketplace framework which enables the doctor to offer for sale specific medical devices that the doctor typically recommends to his or her patients, whether for recovery from surgery or injury. The result is an online marketplace specific to a particular doctor in the form of a website that includes medical devices typically recommended by the doctor. Further, the website may include customizable web pages for the particular patient, which may include medical devices for the patient's particular surgical procedure or injury and body part at issue.

On the patient side, the patient can access the online marketplace, via a web browser, to purchase a medical device recommended by their doctor. In one example embodiment, the online marketplace may include multiple web stores, each one specific to a particular doctor, with each doctor having a portal to an individualized online marketplace. In such an embodiment, the patient may be provided with an access code or other type of login information. When the patient accesses the online marketplace website, the patient can then select their doctor from a provided list (e.g., via a drop down menu or webpage), enter the access code or login information, and enter their doctor's individualized online marketplace. The patient can then select either their surgical procedure or the body part corresponding to the procedure/injury. The patient will then be presented with their doctor's recommended medical device for that procedure, body part, or injury. The patient can then purchase the recommended medical device. Alternatively, the doctor can email or text a link to the product in the online marketplace, so that the patient need only click on the link to view and purchase the product.

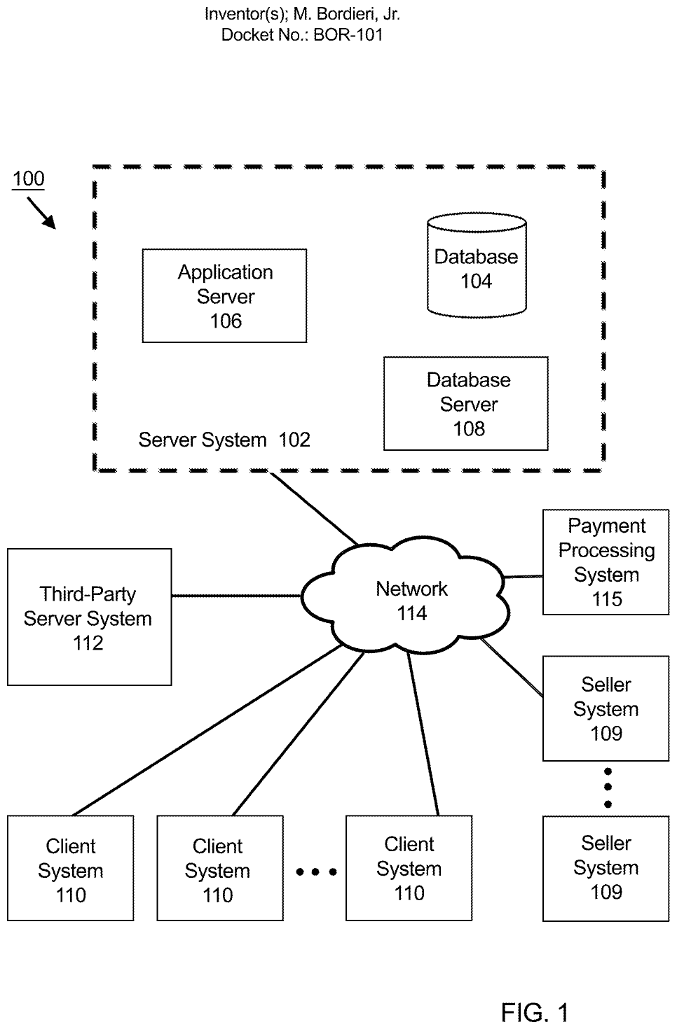

FIG. 1 shows an example embodiment of a system 100 for providing a customizable online marketplace. The system may include a server system 102 which includes a database 104 which stores and provides the information needed to render the website, including product information, other website information, access information for the doctor or patient, and the like, including but not limited to healthcare data analytics, patient information (medical history, contact information, prescription information, etc.), surgery dates and information, doctor preferences, and product descriptions. The server system 102 may also include an application server 106 with the necessary software for rendering or hosting the website(s). A database server 108 may be provided which provides information from the database 104 to the application server 106. Seller systems 109 may be provided which enable secure access to a specific online marketplace for a doctor or medical group via a portal, enabling the doctor or medical group to upload patient information, and to upload product information and product sales listings to their corresponding online marketplace. User systems 110 may be provided which enable secure access to the website by the patient, enabling the patient to select the corresponding online marketplace offered by their doctor, to access recommended product information and purchase one or more of the products recommended by their doctor. Third party server systems 112 may be provided that comprise at least one of one or more third party payment processing systems and/or one or more third party product vendors. Alternatively or additionally, an independent payment processing system 115 may be provided. The server system 102, the seller systems 109, the client systems 110, and the third party systems 112, and the payment processing system 115 may be connected via a network 114.

The network 114 may comprise the Internet, a LAN, a WAN, VPN, or a combination thereof with wired and/or wireless connections. The user systems 110 may be any type of computer device adapted to be connected to the network 114, including but not limited to a computer, a laptop computer, a tablet computer, a smart phone, a smart watch, smart glasses, or other Internet enabled device.

The products may be purchased from the third-party vendors by the operator of the marketplace and stored in one or more distribution facilities, from which they may be shipped direct to the patient after purchase via the online marketplace. Alternatively or additionally, the products (or certain types of products) may be dropped shipped directly from the third-party vendor or manufacturer to the patient once ordered via the online marketplace. The products may also be manufactured or purchased by the operator of the marketplace or provided directly from the manufacturer as a white label product.

In one example embodiment, once the patient accesses the main website, they select their doctor/group/hospital/surgery center etc. Each group may have their own drop-down box. Then the patient will select their group from the dropdown menu and that will bring them to the page to select their individual doctor. Once that group selection is made the patient is essentially entering the doctors “ecommerce Store” meaning the information and monies captured after this point will not be public knowledge and will only be for the doctor/group to see. This also means that the monies spent after this point go to that group or doctor directly and not to the website platform operator or any other group. Essentially this is where the patient leaves the main platform and enters the store for the doctor/group/hospital/surgery center. This is scalable to enable the provision of new “stores” for each doctor/group/hospital/surgery center account.

The store for each doctor/group may comprise a webpage that is custom built/coded specifically for that doctor or group.

Alternatively, rather than accessible through a portal, each doctor/group/hospital/surgery center may have their own custom website that can be directly accessed.

In such an example embodiment, once the patient enters the doctors “store”, the doctors are the ones selling the products to the patients. The products are not being sold via the main platform. Once the patient checks out and pays, the doctor immediately buys the products from the platform or third-party vendor and sells them to the patient. The money is directed to the doctor's bank account and the platform or third-party vendor invoices the doctor for the cost of the products.

Alternatively, the products can be purchased directly from the platform and or a third-party vendor. Whether to sell directly or to make products available to the patient from the vendor or platform may be a choice offered to the doctor when setting up their customizable website. For example, the doctors may be charged a flat rate for the products which include the webstore services, or the doctor's profit is the difference between what the patient pays and what the system operator charges the doctor for the product. For example, the patient pays $100 for a shower chair. The webstore charges the doctor $75. The doctor's profit is $25.

Also important to note is that the physicians can choose to not be involved financially such that the webstore is simply offered as a service and the webstore operator keeps all of the profits, without any revenue to the doctor.

It should be noted that the medical devices offered for sale in the online marketplace are durable medical goods of the non-prescription type not typically covered by insurance, and all purchases will be direct pay purchases by the patient. However, those skilled in the art will appreciate that the methods and systems of the present invention can be expanded to include medical devices covered by insurance and include either prescription processing functionality which enables communication with insurance companies for application of the insurance payment/discount to the purchase of the goods, and/or insurance reimbursement information and processes.

The tech stack info for the website may be as follows:
Current platform—Wordpress Site, MySQL DB
Future State—MERN Stack
   Front-end Technology—React JS
   Backend Technology—MongoDB, NodeJS

Those skilled in the art will appreciate that different tech stacks, platforms, front end and back-end technology may be used to obtain the same results.

It should now be appreciated that the present invention provides advantageous methods and systems for providing a customizable single point of sale online marketplace for the sale of medical devices.

Although the invention has been described in connection with various illustrated embodiments, numerous modifications and adaptations may be made thereto without departing from the spirit and scope of the invention as set forth in the claims.

What is claimed is:

1. A system for providing a customizable online marketplace, comprising:
a database server and database for providing website information over a network;
an application server for rendering a website connected to the database server via the network, the website comprising one or more online marketplaces, each of the one or more online marketplaces being specific to a particular doctor and offering medical devices recommended by the particular doctor for purchase by a patient;
for each of the one or more online marketplaces, a secure seller portal for each doctor to access the corresponding online marketplace and to upload product information and product sales listings to the corresponding online marketplace;
one or more user systems enabling the patient to securely access the website, choose the corresponding online marketplace associated with their doctor, and purchase one or more of the medical devices recommended by their doctor;
a payment processing system in communication with the network for processing the purchases.

2. A system in accordance with claim 1, wherein:
each online marketplace comprises one or more drop down menus listing one or more of medical procedures, body parts, and injuries; and
the selection of a particular medical procedure, body part, or injury from the one or more drop-down menus renders one or more recommended medical devices for purchase by the patient.

3. A system in accordance with claim 1, wherein the patient access to the doctor's corresponding online marketplace may be enabled via a link provided to the patient in a text or email.

4. A system in accordance with claim 1, wherein the portal enables each doctor to upload patient information accessible only by the corresponding patient, including but not limited to medical history, surgical history, contact information, prescription information, and medical device recommendations.

5. A system in accordance with claim 1, wherein the medical devices comprise at least one of durable medical devices provided by the doctors or durable medical devices provided by third-party vendors.

6. A method for providing a customizable online marketplace, comprising:
providing a database server and database for providing website information over a network;
rendering a website via an application server connected to the database server via the network, the website comprising one or more online marketplaces, each of the one or more online marketplaces being specific to a particular doctor and offering medical devices recommended by the particular doctor for purchase by a patient;
providing, for each of the one or more online marketplaces, a secure seller portal for each doctor to access the corresponding online marketplace and to upload product information and product sales listings to the corresponding online marketplace;
providing one or more user systems enabling the patient to securely access the website, choose the corresponding online marketplace associated with their doctor, and purchase one or more of the medical devices recommended by their doctor;
processing the purchases via a payment processing system in communication with the network.

7. A method in accordance with claim 6, wherein:
each online marketplace comprises one or more drop down menus listing one or more of medical procedures, body parts, and injuries; and
the selection of a particular medical procedure, body part, or injury from the one or more drop-down menus renders one or more recommended medical devices for purchase by the patient.

8. A method in accordance with claim 6, wherein the patient access to the doctor's corresponding online marketplace may be enabled via a link provided to the patient in a text or email.

9. A method in accordance with claim 6, wherein the portal enables each doctor to upload patient information accessible only by the corresponding patient, including but not limited to medical history, surgical history, contact information, prescription information, and medical device recommendations.

10. A method in accordance with claim 6, wherein the medical devices comprise at least one of durable medical devices provided by the doctors or durable medical devices provided by third-party vendors.
